(19) United States
(12) Patent Application Publication
(10) Pub. No.: US 2012/0113122 A1
(43) Pub. Date: May 10, 2012

(54) SOUND FIELD VISUALIZATION SYSTEM

(75) Inventors: Takashi TAKAZAWA, Obu-city (JP); Ichiro AKAHORI, Anjo-city (JP); Manabu OTSUKA, Miyoshi-city (JP)

(73) Assignee: DENSO CORPORATION, Kariya-city (JP)

(21) Appl. No.: 13/290,173

(22) Filed: Nov. 7, 2011

(30) Foreign Application Priority Data
Nov. 9, 2010 (JP) 2010-250917
Oct. 26, 2011 (JP) 2011-235106

(51) Int. Cl. G09G 5/22

(52) U.S. Cl. 345/440.1

(57) ABSTRACT

A sound field visualization system includes a sound field display unit, a trigger signal generation section, and a control section. The sound field display unit includes a plurality of sound pressure display sections. Each sound pressure display section includes a sound pressure signal generation portion, a sampling portion, and a display portion. The sound signal generation portion generates a sound pressure signal in accordance with a sound pressure. The sampling portion samples the sound pressure signal based on a trigger signal that is generated by the trigger signal generation section and is supplied from the control section. The display portion creates a display based on the sound pressure signal sampled by the sampling portion.

### CROSS REFERENCE TO RELATED APPLICATIONS

The present application is based on and claims priority to Japanese Patent Applications No. 2010-250917 filed on Nov. 9, 2010, and No. 2011-235106 filed on Oct. 26, 2011, the contents of which are incorporated in their entirety herein by reference.

### TECHNICAL FIELD

The present invention relates to a sound field visualization system.

### BACKGROUND

A sound field visualization system that visualizes sound field is used, for example, for understanding a noise distribution and designing audio equipment. For example, JP-A-2010-60676 discloses a sound field visualization system including a plurality of sound-to-light converters arranged in a sound field space and an imaging device that can take an image at high speed. The sound-to-light converters emit light in accordance with sound pressure. The imaging device takes images of light emission of the sound-to-light converters at high speed. The images are stored once and then are played in slow motion with a playback device. Thus, the sound field visualization system cannot visualize the sound pressure in real time.

JP-A-9-81066 discloses a display device that includes a display body. In accordance with output signals from a plurality of microphones arranged in a sound field space, corresponding portions in the display body are mechanically displaced. Because the display body is mechanically operated, the display with the display body is behind the actual change in the sound field, and the display device cannot visualize the sound field in real time.

### SUMMARY

In view of the foregoing problems, it is an object of the present invention to provide a sound field visualization system that can visualize a sound field on site in real time.

A sound field visualization system according to an aspect of the present invention includes a sound field display unit, a trigger signal generation section, and a control section. The sound field display unit includes a plurality of sound pressure display sections. Each of the sound pressure display sections includes a sound pressure signal generation portion, a sampling portion, and a display portion. The sound signal generation portion measures a sound pressure at a position where the sound signal generation portion is disposed and generates a sound pressure signal in accordance with the sound pressure. The sampling portion samples the sound pressure signal based on a trigger signal. The display portion creates a display based on the sound pressure signal sampled by the sampling portion. The trigger signal generation section generates the trigger signal based on a period of sound supplied to the sound field display unit. The control section supplies the trigger signal generated by the trigger signal generation section to the sampling portion in each of the plurality of sound pressure display sections.

The sound field visualization system can visualize a sound field with the sound field display unit on site in real time.

### BRIEF DESCRIPTION OF THE DRAWINGS

Additional objects and advantages of the present invention will be more readily apparent from the following detailed description of embodiments when taken together with the accompanying drawings. In the drawings:

FIG. 1 is a block diagram showing a sound field visualization system according to a first embodiment of the present disclosure;

FIG. 2 is a block diagram showing a configuration of a converter in the sound field visualization system;

FIG. 3 is a diagram showing a usage example of the sound field visualization system;

FIG. 4 is a graph showing measured values of a sound pressure and a sound pressure waveform in a case where an arrangement interval of converters is 7.5 centimeters and a wavelength of the sound pressure is 34 centimeters;

FIG. 5 is a graph showing measured values of a sound pressure and a sound pressure waveform in a case where an arrangement interval of converters is 7.5 centimeters and a wavelength of the sound pressure is 12.4 centimeters;

FIG. 6 is a graph showing measured values of a sound pressure and a sound pressure waveform in a case where an arrangement interval of converters is 7.5 centimeters and a wavelength of the sound pressure is 7.7 centimeters;

FIG. 7 is a diagram showing a measured result of a sound pressure distribution in a case where an arrangement interval of converters is 7.5 centimeters and a wavelength of a sound pressure is 27.6 centimeters;

FIG. 8 is a diagram showing a measured result of a sound pressure distribution in a case where an arrangement interval of converters is 7.5 centimeters and a wavelength of a sound pressure is 9.7 centimeters;

FIG. 9 is a block diagram showing a sound field visualization system according to a second embodiment of the present disclosure;

FIG. 10 is a block diagram showing a sound field visualization system according to a third embodiment of the present disclosure;

FIG. 11 is a block diagram showing a coupling example of a controller and converters; and

FIG. 12 is a block diagram showing another coupling example of a controller and converters.

### DETAILED DESCRIPTION

### First Embodiment

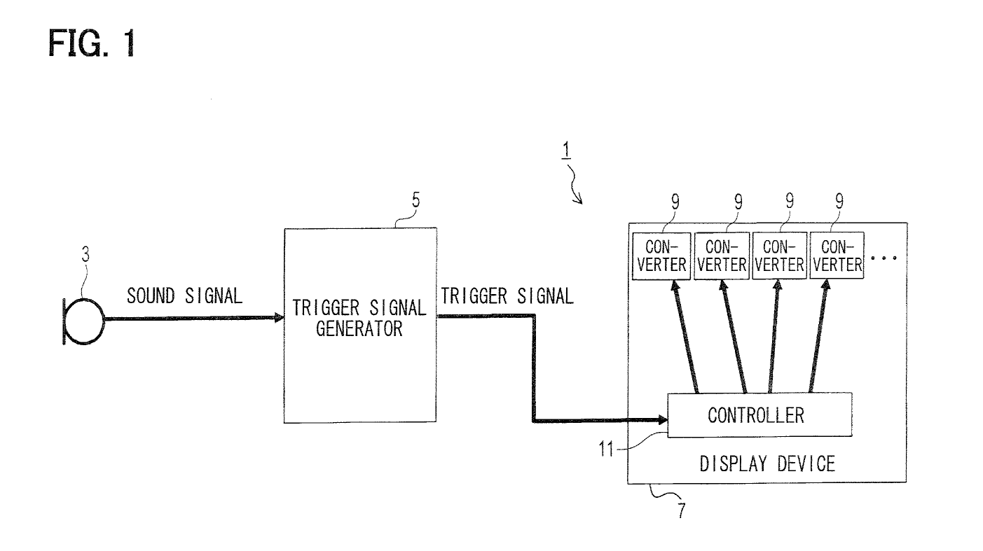

A sound field visualization system 1 according to a first embodiment of the present disclosure will be described with reference to FIG. 1 to FIG. 8.

As shown in FIG. 1, the sound pressure visualization system 1 includes a sound pickup device 3, a trigger signal generator 5, and a display device 7. The sound pickup device 3 can operate as a sound signal generation portion. The trigger signal generator 5 can operate as a trigger signal generation section. The display device 7 can operate as a sound field display unit. The sound pickup device 3 includes a microphone and an amplifier and generates a sound signal from sound generated by a sound source. The sound pickup device 3 is installed at a position where the sound pickup device 3 can pickup sound from the sound source to be displayed with the display device 7.

The trigger signal generator 5 includes a known digital signal processor (DSP). The trigger signal generator 5 receives the sound signal from the sound pickup device 3. The trigger signal generator 5 generates a trigger signal with the DSP based on the sound signal. When a received sound signal has a period T, the trigger signal generator 5 generates a pulse signal having a period nT as the trigger signal. Where, “n” is an integral number and can be optionally selected from 1, 2, 3, 4, 5, 6, . . . . For example, when the received sound signal has a frequency of 500 Hz, a period of the pulse signal may be 2 milliseconds or 4 milliseconds.

The display device 7 includes a plurality of converters 9 and a controller 11. Each of the converters 9 converts a sound pressure into light. Each of the converters 9 can operate as a sound pressure display section. The controller 11 can operate as a control section. The converters 9 may be arranged in a grid pattern on a substrate having a plate shape or a netted shape. The converters 9 are arranged at an interval of D centimeters both in a length direction and a breadth direction. In other words, an arrangement interval of the converters 9 is D centimeters.

The controller 11 can operate as a buffer that supplies the trigger signal from the trigger signal generator 5 to each of the converters 9. The controller 11 also controls a gain, characteristics, and operation of each of each of the converters 9.

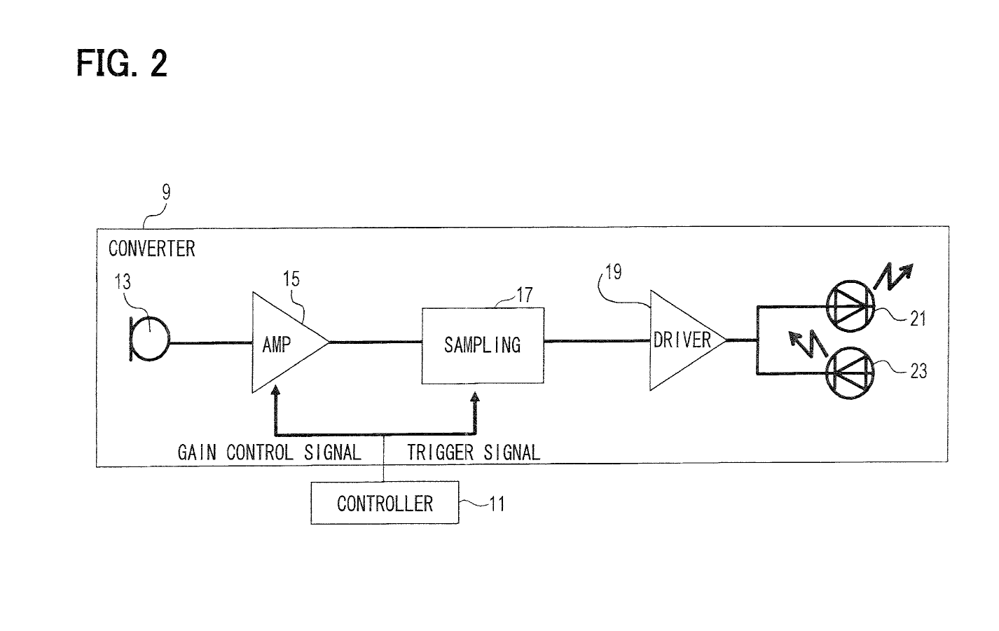

As shown in FIG. 2, each of the converters 9 includes a microphone 13, an amplifier circuit (AMP) 15, a sampling circuit (SAMPLING) 17, a driving circuit (DRIVER) 19, a blue light emitting element 21, and a red light emitting element 23. The microphone 13 can operate as a sound signal generation portion. The sampling circuit 17 can operate as a sampling portion. Each of the blue light emitting element 21 and the red light emitting element 23 can operate as a display portion.

The microphone 13 may be a microphone having a known structure. The microphone 13 measures a sound pressure in a space where the display device 7 is disposed and generates a sound pressure signal in accordance with the sound pressure. The amplifier circuit 15 amplifies the sound pressure signal generated by the microphone 13 to a voltage level required for the sampling circuit 17. The gain of the amplification is controlled based on a gain control signal from the controller 11. The gain control signal is output from the controller 11 to all the converters 9. Thus, the controller 11 can control the gains of the amplifier circuits 15 in all the converters 9 at the same time. The gains may be set by a user by inputting to the controller 11. A gain control signal may be input to the controller 11 from an external device.

The amplifier circuit 15 has a filter function that attenuates a component of the sound pressure signal having a wavelength of less than two times of the arrangement interval D of the converters 9. The sampling circuit 17 samples the sound pressure signal amplified by the amplifier circuit 15 based on the trigger signal from the controller 11. For example, when the pulse signal as the trigger signal is input, that is, when the sampling circuit 17 is in an on-state, the sampling circuit 17 samples the sound pressure signal for a predetermined period. In the other time period, the sampling circuit 17 does not sample the sound pressure signal. The sampling circuit 17 can hold the sampled sound pressure signal until the next pulse signal is input.

The driving circuit 19 amplifies the sampled sound pressure signal to a voltage and a current to activate the blue light emitting element 21 and the red light emitting element 23. The blue light emitting element 21 may be a known light emitting diode that emits blue light. The blue light emitting element 21 is disposed adjacent to the microphone 13 included in the same converter 9. The blue light emitting element 21 emits blue light only when the sound pressure signal amplified by the driving circuit 19 is negative.

The red light emitting element 23 may be a known light emitting diode that emits red light. The red light emitting element 23 is disposed adjacent to the microphone 13 included in the same converter 9. The red light emitting element 23 emits red light only when the sound pressure signal amplified by the driving circuit 19 is positive.

The display device 7 is set in a place where a user wants to measure a sound field. The sound pickup device 3 is set in a place where the sound pickup device 3 can pickup the sound source that generates the sound field to be displayed with the display device 7.

The converters 9 are arranged in a plane. Each of the converters 9 measures a sound pressure at a position thereof, generates the sound pressure signal, and emits light in accordance with the sound pressure signal. Thus, the display device 7 can create a display of a sound pressure distribution in the measured sound field with a lighting state of the converters 9.

The sound pressure signal to be used for emitting light in each of the converters 9 is sampled based on the trigger signal having a period corresponding to sound that generates the measured sound field. Thus, the lighting state of the converters 9 constantly reflects a fixed phase in a periodic change of the sound pressure in the sound field. In other words, the lighting state of the converters 9 does not change with a periodic change in sound pressure but changes in accordance with a wave motion phenomenon such as reflection, diffraction and interference of periodic sound.

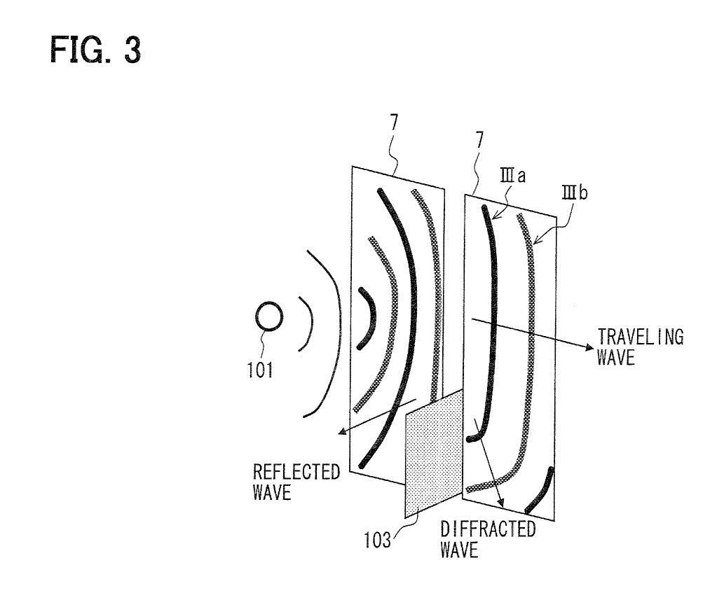

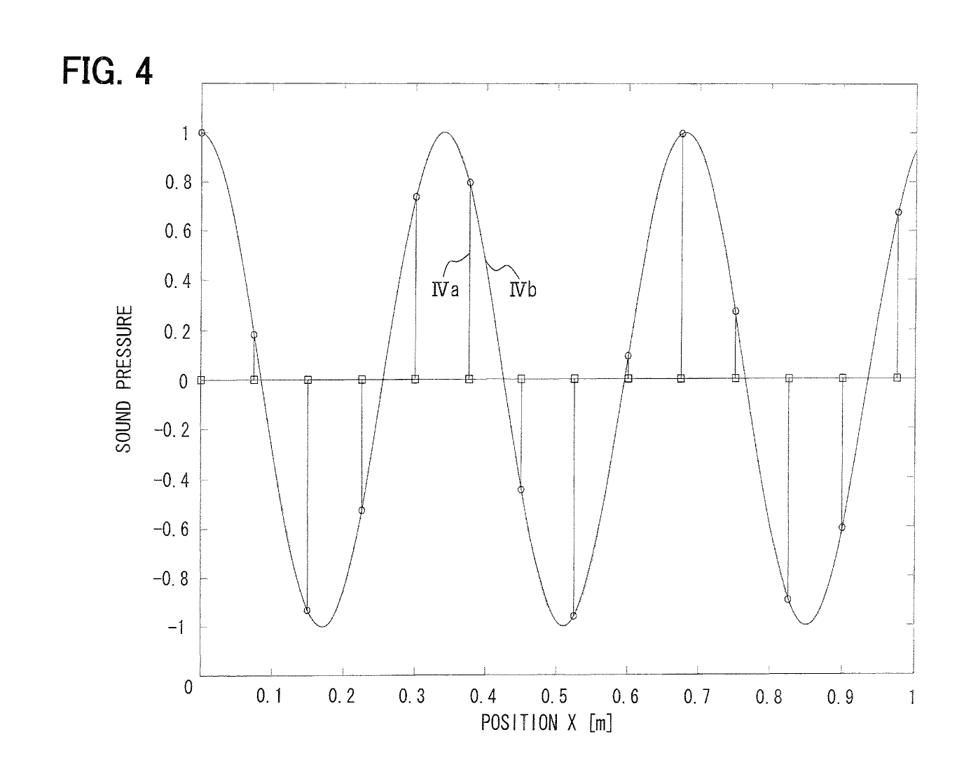

Thus, the lighting state of the display device 7 visualizes the wave motion phenomenon of the periodic sound and change in the wave motion phenomenon on site in real time. For example, as shown in FIG. 3, when the display devices 7 are disposed in front of a sound source 101, a rigid plate 103 is disposed between the display devices 7, and a sine wave is output from the sound source 101, the display device 7 visualizes traveling waves, reflected waves, and diffracted waves with portions IIIa where the blue light emitting elements 21 emit blue light and portions IIIb where the red light emitting elements 23 emit red light. The sound field visualization system 1 can control the gains of the amplifier circuits 15 of all the converters 9 at the same time by the controller 11. Thus, the sound field visualization system 1 can easily control the gains. In each of the converters 9, the amplifier circuit 15 attenuates a component of the sound pressure signal generated by the microphone 13 having a wavelength of less than two times of the arrangement interval D of the converters 9. Thus, the sound field visualization system 1 can visualize the distribution of the sound pressure with certainty. The reasons will be described with reference to FIG. 4 to FIG. 8.

In each of FIG. 4 to FIG. 6, a horizontal axis indicates positions X in the display device 7 in the breadth direction and a vertical axis indicates a sound pressure. Positions with squares are positions where converters 9 are arranged, and circles indicate sound pressure measured with the corresponding converters (see IVa, Va, VIa). Solid curves (IVb, Vc, VIc) indicate changes in the actual sound pressure.

In an example shown in FIG. 4, the arrangement interval D of the converters 9 is 7.5 centimeters, and the wavelength of the sound pressure is 34 centimeters. Thus, the wavelength of the sound pressure is greater than two times of the arrangement interval D of the converters 9. In this case, a waveform of the actual sound pressure (solid curve IVb) can be visualized with the sound pressure (circles IVa) measured with the converters 9. The actual sound pressure waveform has a frequency of 1000 Hz.

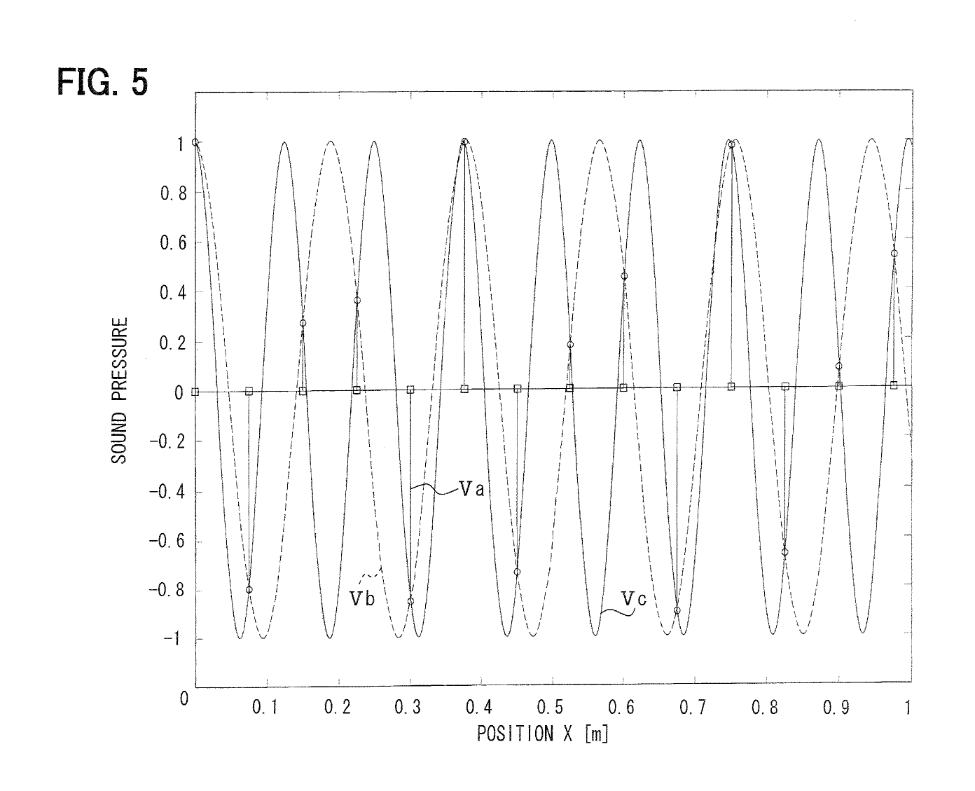

In an example shown in FIG. 5, the arrangement interval D of the converters 9 is 7.5 centimeters, and the wavelength of the sound pressure is 12.4 centimeters. Thus, the wavelength of the sound pressure is less than two times of the arrangement interval D. In this case, the sound pressure (circles Va) measured by the converters 9 shows a sound pressure waveform shown by a dashed curve Vb, which is originally not included, and the actual sound pressure waveform shown by a solid curve Vc cannot be visualized. The sound pressure waveform shown by the dashed curve Vb has a frequency of 1800 Hz and the actual sound pressure waveform has a frequency of 2734 Hz.

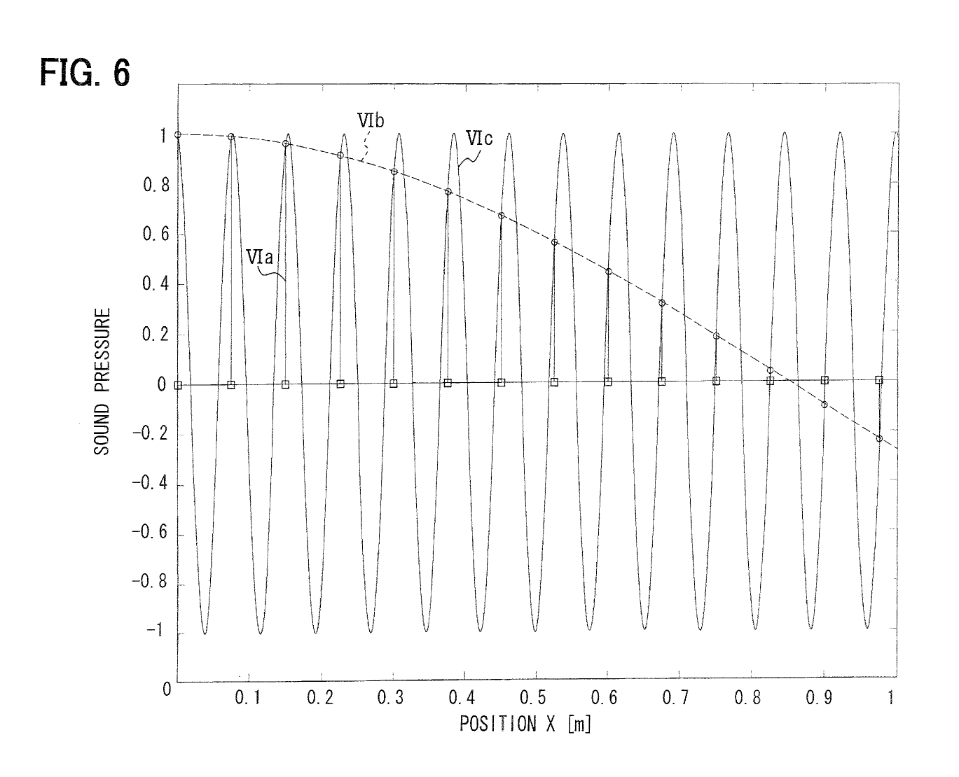

In an example shown in FIG. 6, the arrangement interval D of the converters 9 is 7.5 centimeters, and the wavelength of the sound pressure is 7.7 centimeters. Thus, the wavelength of the sound pressure is less than two times of the arrangement interval D. Also in this case, the sound pressure (circles Vla) measured by the converters 9 shows a sound pressure waveform shown by a dashed curve VIb, which is originally not included, and the actual sound pressure waveform shown by a solid curve VIc cannot be visualized. The sound pressure waveform shown by the dashed curve Vb has a frequency of 100 Hz and the actual sound pressure waveform has a frequency of 4433 Hz.

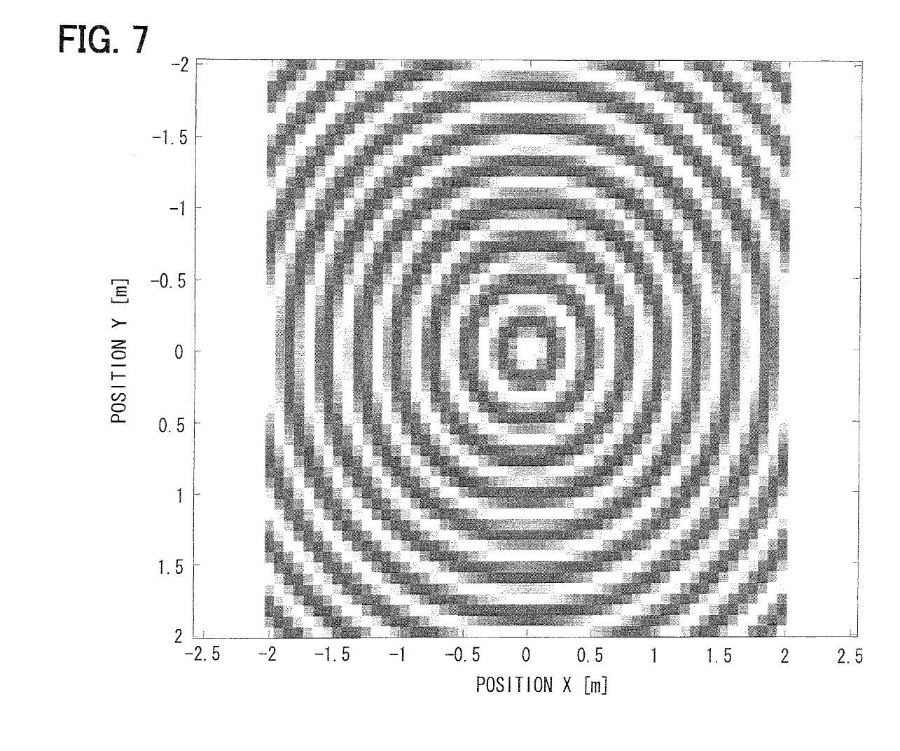

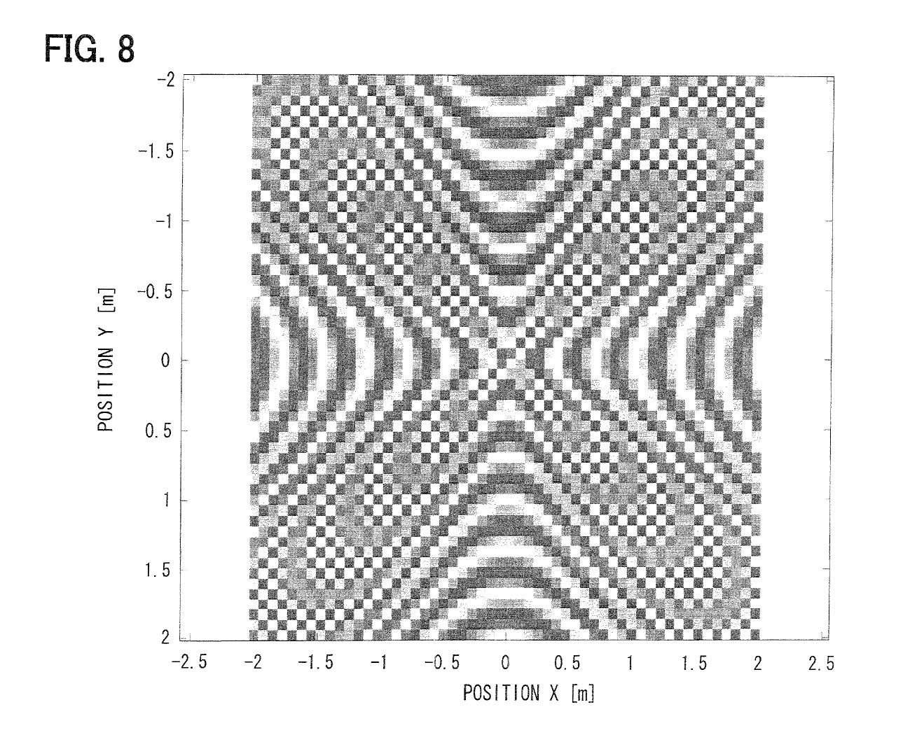

In each of FIG. 7 and FIG. 8, a horizontal axis indicates positions X in the display device 7 in the breadth direction, a vertical axis indicates positions Y in the display device 7 in the length direction, and light and dark indicate a sound pressure. In each of FIG. 7 and FIG. 8, a sound pressure distribution of sound generated from a point sound source at a center is measured with the display device 7. In an example shown in FIG. 7, the arrangement interval D of the converters 9 is 7.5 centimeters, and the wavelength of the sound pressure is 27.6 centimeters. Thus, the wavelength of the sound pressure is greater than two times of the arrangement interval D. In this case, a sound pressure distribution spreading concentrically from the center can be visualized correctly.

In an example shown in FIG. 8, the arrangement interval D of the converters 9 is 7.5 centimeters, and the wavelength of the sound pressure is 9.7 centimeters. Thus, the wavelength of the sound pressure is less than two times of the arrangement interval D. In this case, a component having a wavelength of 27.6 cm, which is originally not included, is shown in the breadth direction and the length direction.

As described above, when the wavelength of the sound pressure is less than two times of the arrangement interval D of the converters 9, a sound pressure waveform which is originally not included is seen. However, when the amplifier circuit 15 attenuates a component having a wavelength of less than two times of the arrangement interval D of the converters 9, such an issue can be restricted. The sampling circuit 17 can hold the sampled sound pressure signal until the next trigger signal is input. Because the blue light emitting element 21 or the red light emitting element 23 keeps emitting light for a period without sampling, the display is easily visible. When the next trigger signal is input, the sampling circuit 17 ends holding, and the converters 9 emit light based on the sound pressure signal that is newly sampled. The trigger signal generator 5 generates the trigger signal using the DSP based on the period of the sound signal. Thus, the trigger signal generator can generate the trigger signal not only when the sound signal is a sine wave but also when the sound signal is musical instrument sound, voice, or pulse train including a lot of harmonics.

### Second Embodiment

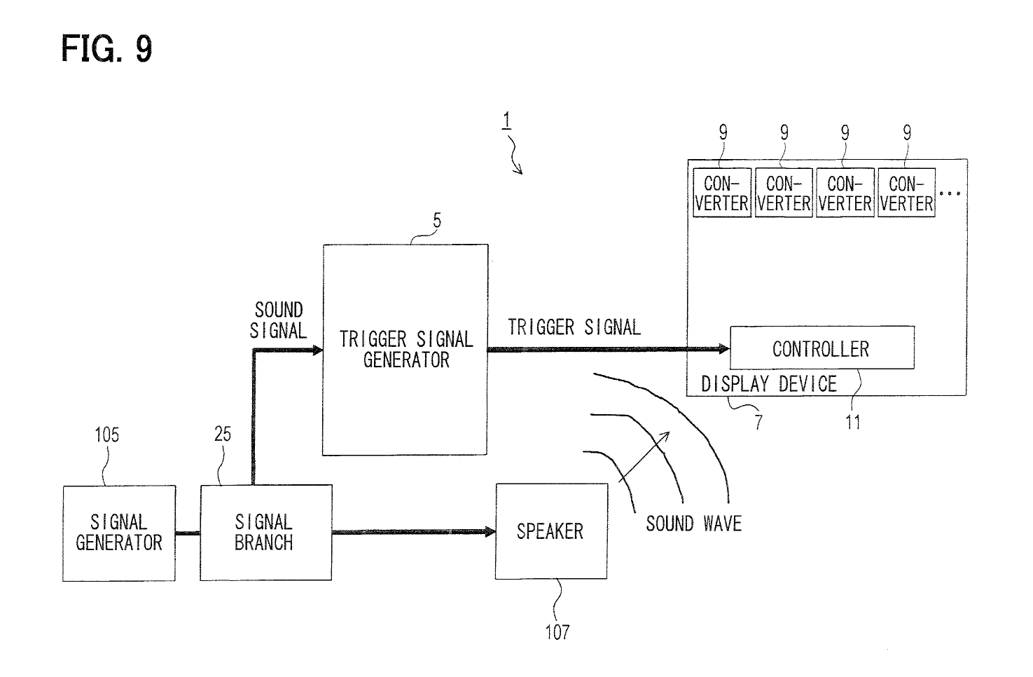

A sound field visualization system 1 according to a second embodiment of the present disclosure will be described with reference to FIG. 9.

The sound field visualization system 1 includes a trigger signal generator 5, a display device 7, and a signal branch device 25. The trigger signal generator 5 can operate as a trigger signal generation section and a sound signal acquisition portion. The display device 7 can operate as a sound field display unit. The trigger signal generator 5 and the display device 7 according to the present embodiment can have configurations similar to the trigger signal generator 5 and the display device 7 according to the first embodiment. The signal branch device 25 branches a sound signal supplied from a signal generator 105 to a loudspeaker 107 and outputs the sound signal to the trigger signal generator 5. The sound signal is used by the loudspeaker 107 for generating sound that generates a sound field measured with the display device 7. The trigger signal generator 5 generates a trigger signal based on the sound signal from the signal branch device 25 and outputs the trigger signal to the controller 11.

The sound field visualization system 1 according to the present embodiment can achieve effects similar to the effects of the sound field visualization system 1 according to the first embodiment. In addition, because the trigger signal is generated using the sound signal output from the signal generator 105, the sound field visualization system 1 does not need a microphone for acquiring a sound signal for generating the trigger signal.

### Third Embodiment

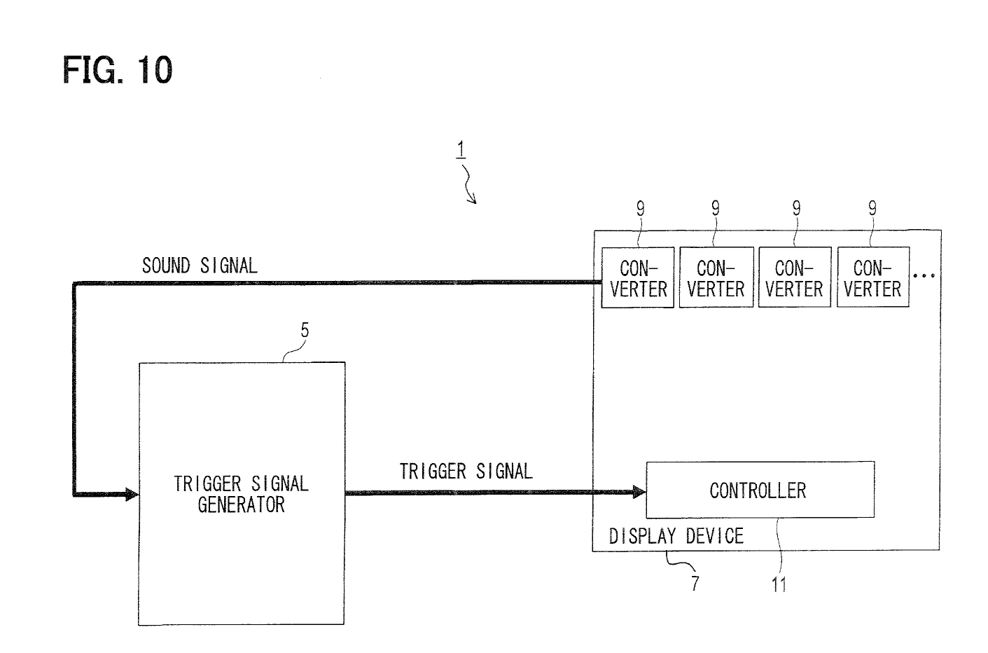

A sound field visualization system 1 according to a third embodiment of the present disclosure will be described with reference to FIG. 10.

The sound field visualization system 1 includes a trigger signal generator 5 and a display device 7. The trigger signal generator 5 can operate as a trigger signal generation section. The display device 7 can operate as a sound field display unit. The trigger signal generator 5 and the display device 7 according to the present embodiment can have configurations similar to the trigger signal generator 5 and the display device 7 according to the first embodiment.

In the present embodiment, a sound signal (a sound pressure signal) amplified by the amplifier circuit 15 is picked up from one of a plurality of converters 9 (see FIG. 2) and the trigger signal generator 5 generates a trigger signal based on the sound signal in a manner similar to the first embodiment.

The trigger signal generator 5 outputs the trigger signal to the controller 11.

The sound field visualization system 1 according to the present embodiment can be used in a manner similar to the sound field visualization system 1 according to the first embodiment and can achieve similar effects.

In addition, because the sound field visualization system 1 according to the present embodiment generates the trigger signal using the sound signal picked up from one of the converters 9, a phase (lighting state) of the converter 9 does not change even when a sound source moves. In cases where a sound source moves around the converter 9, a change in sound pressure around the converter 9 can be clearly shown on the basis of the display of the converter 9.

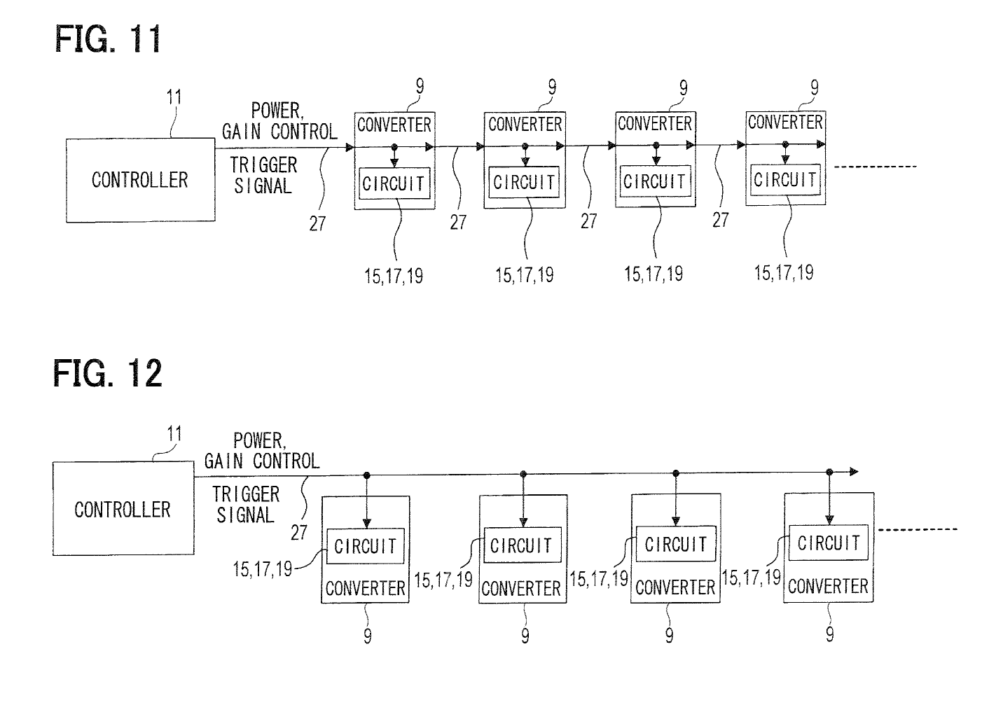

Although the present invention has been fully described in connection with the above-described embodiments thereof with reference to the accompanying drawings, it is to be noted that various changes and modifications can be made within a scope of the present invention. For example, as shown in FIG. 11, the trigger signal, the gain control signal, and the power may be supplied to each of the converters 9 through a signal line 27 that couples the controller 11 and the converters 9 in series. As shown in FIG. 12, the signal line 27 may include a single line or a pack of lines, and the converters 9 may also be coupled with the signal line 27. In the present case, the signal line 27 can have a simple structure. In each of the converters 9, the power for the amplifier circuit 15 and the power for the driving circuit 19 may be supplied separately so as to restrict interference, such as power voltage fluctuation, between the amplifier circuit 15 and the driving circuit 19.

When the sound signal used for generating the trigger signal has a period T, a period of the trigger signal can be shifted from nT, where n is an integral number. Accordingly, a wavefront displayed by the converters 9 can be gradually advanced or delayed with time. For example, a frequency obtained by multiplying the frequency of the trigger signal before compensation by a predetermined factor may be set as a compensated frequency of the trigger signal. When the compensated trigger signal is used, even if a frequency of sound changes, the wavefront moves at a fixed speed. For example, when the frequency is shifted 0.3%, the display device can create a display of the sound field as if a sound speed is 1 m/s. The predetermined factor can be set so that the movement of the wavefront displayed by the display device 7 can be visible to the naked eyes. For example, when the display device 7 has a 1-meter square shape, the frequency may be shifted from −0.3% to +0.3%. When the display device 7 has a 10-meter square shape, the frequency may be shifted from −3% to +3%.

The trigger signal generator 5 may also generate the trigger signal by an analog process such as a level detecting method. Each of the amplifier circuit 15 may have a filter function such as an A-weighting that attenuates a low-frequency sound and a high-frequency sound human cannot hear.

The converters 9 may be arranged optionally in a two-dimensional plane. The converters 9 may also be arranged three-dimensionally. In this case, the sound field can be visualized three dimensionally on site in real time.

What is claimed is:

1. A sound field visualization system comprising:
a sound field display unit including a plurality of sound pressure display sections, each of the plurality of sound pressure display sections including a sound pressure signal generation portion, a sampling portion, and a display portion, the sound signal generation portion measuring a sound pressure at a position where the sound signal generation portion is disposed and generating a sound pressure signal in accordance with the sound pressure, the sampling portion sampling the sound pressure signal based on a trigger signal, the display portion creating a display based on the sound pressure signal sampled by the sampling portion;
a trigger signal generation section generating the trigger signal based on a period of sound supplied to the sound field display unit; and
a control section supplying the trigger signal generated by the trigger signal generation section to the sampling portion in each of the plurality of sound pressure display sections.

2. The sound field visualization system according to claim 1,
wherein the trigger signal generation section includes a sound signal generation portion that measures the sound supplied to the sound field display unit and generates a sound signal, and
wherein the trigger signal generation section generates the trigger signal based on the sound signal generated by the sound signal generation portion.

3. The sound field visualization system according to claim 2,
wherein the sound signal generation portion includes the sound pressure signal generation potion in one of the plurality of sound pressure display sections.

4. The sound field visualization system according to claim 1,
wherein the trigger signal generation section includes a sound signal acquisition portion that acquires a sound signal used for generating the sound supplied to the sound field display unit, and
wherein the trigger signal generation section generates the trigger signal based on the sound signal acquired by the sound signal acquisition portion.

5. The sound field visualization system according to claim 1, further comprising
a gain control section controlling a gain of the sound pressure signal of each of the plurality of sound pressure display sections.

6. The sound field visualization system according to claim 1,
wherein the plurality of sound pressure display sections is arranged at a predetermined interval, and
wherein each of the plurality of sound pressure display sections including a filter portion that attenuates a component of the sound pressure signal having a wavelength of less than two times of the predetermined interval.

7. The sound field visualization system according to claim 1,
wherein the trigger signal has a first frequency, the sound supplied to the sound field display unit has a second frequency, and the first frequency is a frequency obtained by multiplying the second frequency by a predetermined factor.

8. The sound field visualization system according to claim 1,
wherein each of the plurality of sound pressure display sections includes a hold portion that holds the sound pressure signal sampled by the sampling portion.

9. The sound field visualization system according to claim 1, further comprising
a signal line coupling the control section and the plurality of sound pressure display sections in series,
wherein the control section supplies the trigger signal to the sampling portion in each of the plurality of sound pressure display sections through the signal line.

10. The sound field visualization system according to claim 1,
wherein the trigger signal generation section includes a digital signal processor, and the trigger signal generation section generates the trigger signal using the digital signal processor.

11. The sound field visualization system according to claim 1, wherein
the display portion in each of the plurality of sound pressure display sections includes a light emitting diode and creates the display by emitting light from the light emitting diode.
